(19) United States
(12) Patent Application Publication
(10) Pub. No.: US 2010/0060023 A1
(43) Pub. Date: Mar. 11, 2010

(54) ATV universal safety bar

(76) Inventor: Terry Wayne Adkins, Raccoon, KY (US)

Correspondence Address: TERRY W. ADKINS, P.O Box 2602, Pikeville, KY, 41502, US

(21) Appl. No.: 12/231,590

(22) Filed: Sep. 5, 2008

(51) Int. Cl. B62D 39/00

(52) U.S. Cl. 296/1.04

(57) ABSTRACT

The “ATV Universal Safety Bar” is universal in nature meaning that it is intented to fit most any ATV that has a rear trailer towing device.

Its purpose is to prevent an ATV from flipping backward, causing injury or death. The intended purpose of this device is for safety. It should fit most all older ATV's as well as new ones. It is designed with a spring action when the wheel comes in contact with the surface and when the front of the ATV begins to rear upward.

The safety bar will probably be manufactured to be assembled by the consumer. The metal tubing (pipe) will be approximately 3″ in diameter about 1′6″ long. The spring shock that the wheel is mounted to will be approximately 6″ long. The wheel mounted to the spring shock will be approximately 5″ in diameter.

The coupling connected to the trailer towing mount can have at least two different designs to fit various ATV's.

### PURPOSE OF THE INVENTION

The purpose of the “ATV Universal Safety Bar” is to keep an ATV (all Terain Vehicle) from flipping back. It's a safety device to protect lives from danger when on an upgrade or any place where the vehicle could possibly flip back, causing injury to a person. Its design is universal which should work on almost any ATV.

### DESIGN SPECIFICATIONS

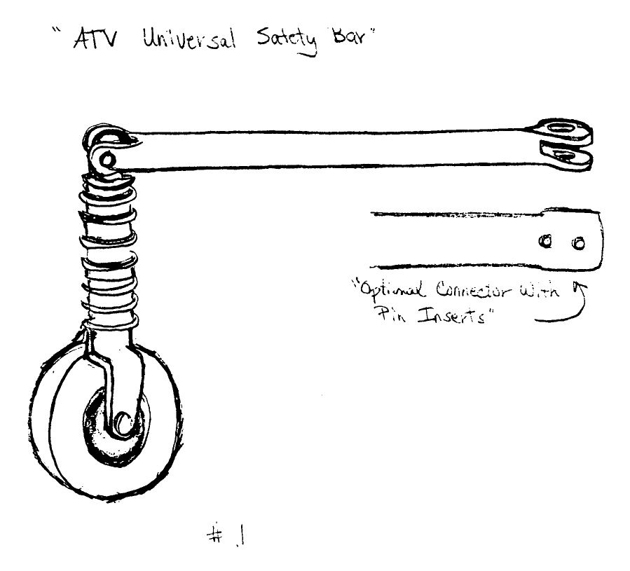

FIG. 1

FIG. 1 shows the universal safety bar that will fit two different styles of trailer hitch designs. The design that uses a bolt and a nut (picture #2), and another design that uses a pin where the safety bar slides into the trail hitch holder (receptor) (picture #3). The safety bar shown in picture #1 to be made and manufactured would use approx. a 3″ diameter steel pipe about 1′6″ long, one end made to connect to the ATV trailer hitch holder. The other end is designed with a special-designed spring-loaded shock with an approx. 4″ or 5″ (Rubber or plastic) wheel mounted onto it. This is to give spring support when going up a hill. The safety bar will keep the front of the ATV from raising up and flipping backwards, causing injury or death. The safety bar needs to be made of strong, high-grade steel.

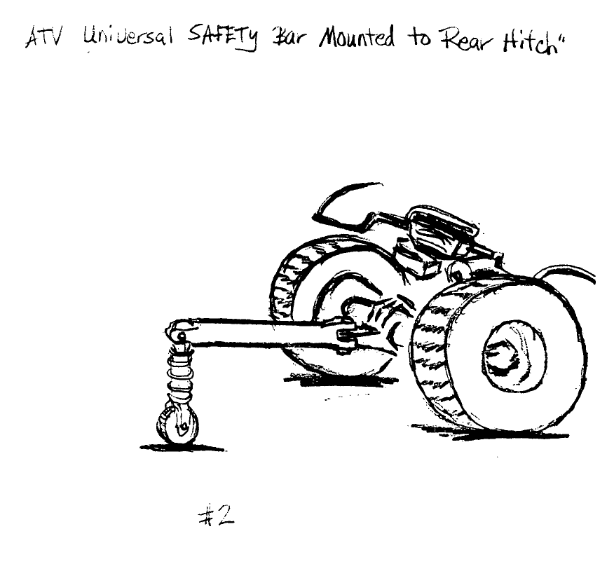

FIG. 2

FIG. 2 shows the safety bar mounted on an ATV, showing the purpose of keeping the ATV from flipping back. It shows it mounted in the place where the trailer hitch ball goes, or the safety bar can be removed when the trailer hitch ball needs to be used for pulling a trailer, etc.

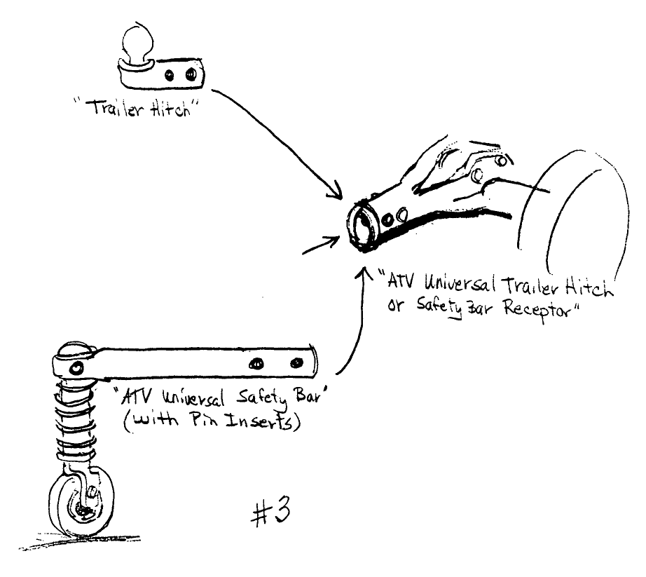

FIG. 3

FIG. 3 shows the safety bar made for a trailer hitch holder (receptor) that uses the ball that slides into the holder and uses a pin rather than a bolt. It is made the same as #1 and #2 except for the end that connects the ATV is different which uses a pin to mount and hold the safety bar to the trailer hitch holder (receptor). It shows a view of safety bar (#3) on page #1 as an optional connector with pin inserts.

### STATEMENT

There are no changes in the substitute specification and contains no new matter.

1. I claim rights as the inventor to the ATV Universal Safety Bar for the purpose of keeping an ATV from flipping back.
The ATV Universal Safety Bar is designed for AU Terain Vehicles for the purpose as a safety device to keep the vehicle from flipping back, causing injury or death. The device is universal because it is designed to fit most all ATV's. There can be different connectors when connecting the safety bar to the ATV as shown in drawing #1 and #3. Also, a quick link could be used as a connector. The quick link would be connected to a trail hitch ball. The quick link could be made like the connector that connects a trailer to a hitch.
The connector shown in drawing #2 is used to bolt to a trailer hitch that most all ATV's come with from the factory.
Another type connector is shown as optional connector in drawing #1 and #3 which is installed with a pin(s). It slides in the ATV receptor that is held by a pin(s) in drawing #3. The safety bar is approx. 3″ in diameter and approx. 1′6″ long. On the end that comes into contact with the ground (if the front of the ATV raises up) it has a shock for fixable support with an approx. 4″ or 5″ plastic or rubber wheel. The wheel comes in contact with the ground and supports the ATV, preventing the vehicle from flipping back.
